(19) United States
(12) Patent Application Publication
(10) Pub. No.: US 2014/0059846 A1
(43) Pub. Date: Mar. 6, 2014

(54) METHOD FOR THE MANUFACTURE OF ELECTRODES

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/985,264

(22) PCT Filed: Jan. 26, 2012
(86) PCT No.: PCT/EP12/00356

§ 371 Date: Nov. 21, 2013

(30) Foreign Application Priority Data
Feb. 14, 2011 (DE) 10-2011-011-156.5

(51) Int. Cl. H01M 4/139; H01M 10/052

(52) U.S. Cl. CPC H01M 4/139; H01M 10/052
USPC 29/623.1

(57) ABSTRACT

Method for manufacturing an electrode, in particular a negative electrode of an electrochemical cell, comprising the step of: drying a material of the electrode to be dried by means of a temperature gradient, wherein UV irradiation is present during the step of drying.

The entire content of priority application DE 10 2011 011 156.5 is herewith incorporated by reference into the present application.

The present invention relates to a method for the production of electrodes, particularly for negative electrodes, for electrochemical cells. These electrochemical cells can be preferably used for powering a vehicle having an electrical motor, preferably with hybrid drive and/or in “plug in” mode.

Electrochemical cells, in particular lithium secondary batteries are used for energy storage in mobile information equipment such as mobile phones, in power tools or electrically powered cars and in cars with hybrid drive, due to their high energy density and high capacity. In these different applications, in particular in regard to powering automobiles, these electrochemical cells must meet high demands: high capacitance and energy density, which remains stable over a large number of charge and discharge cycles, while having as minimal a weight as possible.

In particular the useful time of life of electrochemical cells is often dependent on the aging of the electrodes, in particular the aging of the negative electrodes. In the aging process, electrochemical cells lose capacity and performance. This process takes place, to some extent, in most of the common electrochemical cells, and is highly dependent on the operating conditions (temperature, storage conditions, state of charge, etc.) but also on the quality and the processing of the materials during the manufacturing process of the electrochemical cell. Thus, high-quality processing of pure materials leads to long-lived electrochemical cells that age only little over a long period of time, i.e. loose little capacity and performance over time.

Since the purity of the materials used is often subjected to physical or chemical limits, for example due to synthesis, a primary objective of a battery manufacturer is to obtain electrochemical cells of higher quality and therefore more durable electrochemical cells by means of optimizing the manufacturing process of the electrodes, such as disclosed in EP 2 006 942.

In the light of the prior art, one object of the invention is to provide an improved process (method) for the production of electrodes, particularly for negative electrodes, of durable electrochemical cells.

This is achieved according to the teaching of the independent claims of the present invention. Preferred embodiments of the invention are the subject matter of the dependent claims.

To solve this problem, as will be described in detail below, a method for the manufacture of electrodes for electrochemical cells is provided, in particular of negative electrodes, comprising the step of: drying a material of the electrode that is to be dried by means of a temperature gradient, wherein in the step of drying comprises at least one UV radiation.

The step of drying a material that is to be dried by means of a temperature gradient is associated with the advantage that the drying may be carried out gently, while it is efficient nevertheless

UV irradiation of the material of the electrode that is to be dried is associated with the advantage that impurities, especially organic impurities may be removed gently and efficiently, at least partially, by means of oxidation, This primarily results in decomposition product that are safe and easy to be removed, such as water and CO₂. Thus, the material of the electrode that is to be dried, is at least partially cleaned by UV irradiation. In particular, in case the material to be dried is the metallic substrate of the electrode, the adhesive forces of the surface of the metallic substrate are at least partially increased, which leads to improved adhesion of the electrochemically active material on the metal collector, and thus to an improved durability of the electrode.

The term “electrochemical cell” is understood to mean any device for the electric storage of energy. The term therefore defines, in particular, electrochemical cells of the primary or secondary type, but also relates to other forms of energy storage devices, such as capacitors. A preferred electrochemical cell in accordance with the present invention is a lithium ion battery cell.

The term “negative electrode” means that the electrode provides electrons to a load, for example when connected to an electrical motor. Thus, the negative electrode is the anode in accordance with this convention. Correspondingly, the term “positive electrode” means that the electrode takes up electrons when connected to a load, for example to an electrical motor. Thus, the positive electrode is the cathode in accordance with this convention.

An electrode, i.e. a positive electrode and/or a negative electrode, which is produced by the method of the invention comprises at least a metallic substrate (collector) and at least an electrochemically active material.

In one embodiment, the electrode as prepared in accordance with the present invention comprises, in addition to the metallic substrate and the electrochemically active material, at least one further additive, preferably an additive for increasing the conductivity, such as a carbon-based material, such as carbon black, and/or a redox-active additive, which reduces, preferably minimizes, and preferably prevents, the destruction of the electrochemically active material in the event of overload of the electrochemical cell.

The term “metallic substrate” preferably refers to the part of cell, which is known as “electrode support” or “collector”.

Preferably, the metallic substrate is at least partially configured as a film or a net structure or a mesh/web (“Gewebe”), preferably comprising copper or a copper-containing alloy, in particular as rolled copper, in particular as a copper sheet.

In a further embodiment, the metallic substrate comprises aluminum.

In one embodiment, the metallic substrate may be configured as a sheet, web or woven structure, which preferably at least partially comprises plastics.

In a preferred embodiment, the metallic substrate, particularly its surface, is pretreated so that the adhesive force of the surface is at least partially increased. This is achieved, for example, by a wet-chemical treatment with acid, particularly an organic acid, and/or by means of UV irradiation.

Suitable UV-radiation source are, for example, mercury vapor lamps, in particular low-pressure mercury lamps.

The term “temperature gradient” is to be understood to mean that the temperature changes along an elongation (i.e. a certain pathway). The change in temperature along an elongation can be implemented to be continuous or to be non-continuous, for example in steps. The temperature may rise or fall along such an elongation (pathway), or may increase or decrease. It follows, then, that at a point “x” of said elongation/pathway, the temperature may be higher or lower or the same as the temperature at another point “y” of said elongation/pathway.

One advantage of using a temperature gradient is that the temperature may be increased slowly, and thus in a manner that is gentle vis-à-vis the material to be dried, until the temperature required for the drying the material to be dried is achieved. Thus, the drying is gentle, yet effective.

In one embodiment, the electrode material to be dried is a metallic substrate whose surface has been treated with a paste comprising a liquid, for example NMP, and an electrochemically active material suspended therein, preferably a material based on carbon. In this case, the drying by means of temperature gradient is particularly advantageous. The advantage, in this case, in respect to the electrodes is that the material to be dried, i.e. the coated substrate, is heated up slowly so that the liquid contained evaporates slowly and boiling retardation, which may cause flaking-off of the electrochemically active material off the upper face of the substrate, is at least partially prevented. Thus, an electrode may be obtained, the durability of which is improved by means of improving the adhesion of the electrochemically active material onto the surface of the metallic substrate, in particular onto a metal collector (substrate) surface.

The term “to flake off” is understood to mean that the adhesion between the electrochemically active material and metal collector surface is negatively affected, in particular is impaired, or even no longer exists.

In a preferred embodiment, the temperature gradient is not larger than 100° C., preferably in the range from 10° C. to 80° C., more preferably in the range of 30° C. to 60° C.

In a preferred embodiment, the drying takes place, at least partially, under a protective gas. The protective gas may comprise all gases which do not enter into a reaction with the material to be dried at the time of the drying, under the corresponding conditions, i.e., for example, at high temperatures. Suitable gases are, for example, CO₂, N₂ or Ar. The use of such protective gas has the advantage that the material to be dried does not come into contact with ambient air, and, in particular, not in contact with oxygen, and thus prevents the material to be dried, in particular, to react with oxygen.

Furthermore, it should be noted that the term “ambient air” is meant to relate to that kind of air, which is provided within the drying apparatus. This air may have the composition of breathable air, which is also predominantly present outside of the drying apparatus. However, it is also possible that said “ambient air” contains other components, such as vaporized solvents or that it is present in other proportions in regard to the components which make up the breathable air, for example, an increased concentration of water vapor or a reduced concentration of oxygen.

“Ambient Conditions” are meant to relate to pressure and temperature as they prevail within the drying apparatus.

In one embodiment, the material to be dried preferably is the metallic substrate (collector) of the electrode. The drying step may be performed before or after a pretreatment of the surface of said substrate/collector.

In a particularly preferred embodiment, the material to be dried is a metallic substrate, the surface of which is pretreated wet-chemically, particularly cleaned, in particular with an organic acid, in particular with oxalic acid, which is preferably dissolved in NMP.

In a further preferred embodiment, the material to be dried is a metallic substrate, the surface of which has been coated with an electrochemically active material.

In one embodiment, the entire drying takes place in the absence of air, in particular in the absence of oxygen, and under a protective gas atmosphere.

In another embodiment, the drying takes place only under partial exclusion of air, in particular of oxygen, and under an inert gas atmosphere.

The drying (step) may be followed by a storage step, which also, at least partially, is conducted under the exclusion of air, in particular of oxygen and/or under a protective gas atmosphere.

The drying may be divided into a plurality of partial steps, preferably in steps of up to ten, preferably up to six sub-steps, preferably up to three sub-steps. These sub-steps may be distinguished from each other by means of different parameters, which may be relevant for the drying process, in particular in regard to the surrounding environment (atmosphere), to which the electrode is exposed to during treatment or coating, in particular selected from: temperature, pressure, atmosphere used (for example, inert gas or ambient air), type of drying (for example, vacuum application, hot air blower, IR lamps or mechanical drying, for example by means of suction, wiping, or pressing), UV irradiation, or combinations thereof.

A slow increase of the temperature over time, in several successive steps, is particularly advantageous.

In one embodiment, a first sub-step is conducted at a first temperature, which is different from a reference temperature, in particular is increased. It is preferred that a first temperature is up to 10° C., preferably up to 30° C., preferably up to 50° C., preferably up to 70° C. higher than the reference temperature. Preferably, the first temperature does not exceed 100° C. The atmosphere may contain protective gas or ambient air. The pressure may be different from a reference pressure, in particular may be lowered vis-à-vis said reference pressure, but also may be equal to the reference pressure.

In one embodiment, a second sub-step is conducted at a second temperature, which is different from a reference temperature, in particular is increased. It is preferred that a second temperature is up to 10° C., preferably up to 30° C., preferably up to 50° C., preferably up to 70° C. higher than the reference temperature. Preferably, the second temperature does not exceed 100° C. The atmosphere may contain protective gas or ambient air. The pressure may be different from a reference pressure, in particular may be lowered vis-à-vis said reference pressure, but also may be equal to the reference pressure.

In a further preferred embodiment, a third sub-step comprises a UV irradiation of the material to be dried, at a third temperature. The third temperature may be equal to the first temperature or to the second temperature or to the reference temperature. However, the third temperature may also be different from the first temperature or the second temperature or the reference temperature. The atmosphere may contain protective gas or ambient air. The pressure may be different from a reference pressure, in particular may be lowered vis-à-vis said reference pressure, but also may be equal to the reference pressure.

In one embodiment, a fourth sub-step is conducted at a fourth temperature, which is different from the reference temperature, and/or is different from the first temperature and/or is different from the second temperature and/or and or is different from the third temperature, and in particular is increased vis-à-vis at least one of these temperatures. Preference is given to a fourth temperature which is preferably higher by up to 10° C., preferably by up to 30° C., preferably by up to 50° C., preferably by up to 70° C. than the reference temperature. Preferably, the fourth temperature does not exceed 100° C. The atmosphere may contain protective gas or ambient air. In sub-step four, a protective gas atmosphere (for example argon) is particularly preferred. The pressure may be different from the reference pressure, in particular, may be reduced, but also may be equal to the reference pressure.

The reference pressure is the external pressure and the reference temperature may mean the outside temperature. The terms “external pressure” and “outside temperature” denote the pressure and the temperature, which prevail outside of the device within which the drying takes place. In case, for example, the drying apparatus is situated in a production hall, then temperature and pressure, which predominate in the production hall, but outside of the drying apparatus, are referred to. The reference temperature is preferably 25° C. and the reference pressure is preferably 1.031 bar.

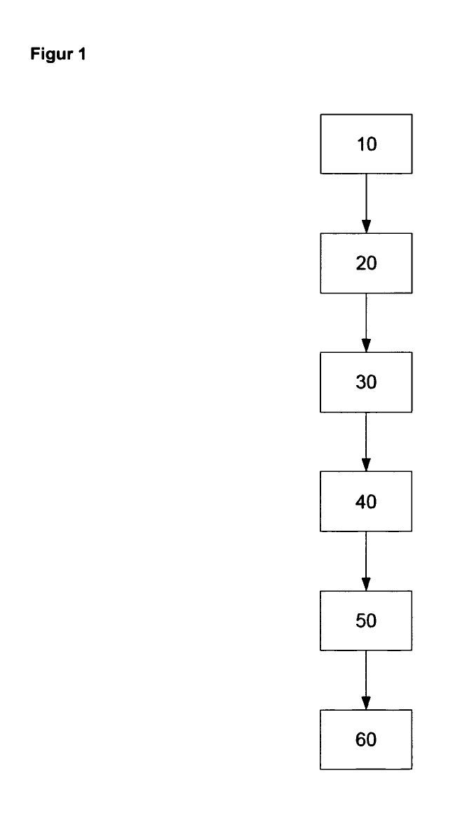

FIG. 1 schematically illustrates an embodiment in accordance with the present invention.

This embodiment of the method for manufacturing an electrode comprises the steps of:
Provision of material of an electrode that is to be dried (10).
carrying out the drying, in a first segment, at a temperature, which is higher than in step (10), preferably up to 20° C. higher, but not higher than 100° C. (20).
carrying out the drying, in a second segment, at a temperature which, is higher than in step (20), preferably up to 20° C. higher, but not higher than 100° C. (30).
carrying out the drying, with an additional UV irradiation, in a third segment, at a temperature which is higher than in step (30), preferably up to 20° C. higher, but not higher than 100° C. (40).
carrying out the drying, in a fourth segment, at a temperature, which is higher than in step (30), preferably up to 20° C. higher, but not higher than 100° C., under a protective gas atmosphere (50).
storage of the dried material of an electrode, preferably under a protective gas (60).

1. A method for manufacturing an electrode, in particular a negative electrode of an electrochemical cell, comprising the steps of:
Drying of a material of the electrode to be dried the, by means of a temperature gradient, characterized in that
in the step of drying, at least one UV radiation is contained.

2. Method according to claim 1, characterized in that the temperature gradient is not greater than 100° C.

3. Method in accordance with claim 1, characterized in that the drying
comprises a first drying step at a first temperature,
a second drying step at a second temperature,
a third drying step at a third temperature, and
a fourth drying step at a fourth temperature.

4. Method according to claim 3, characterized in that an UV irradiation of the material to be dried is performed in the third drying step.

5. Method according to claim 1, characterized in that the drying takes place, at least partially, under a protective gas.

6. Method according to claim 1, characterized in that the material to be dried comprises a metallic substrate.

7. Method according to claim 1, characterized in that the material to be dried is provided as a metallic substrate, which is at least partially coated with an electrochemically active material.

8. Method according to claim 6, characterized in that the metallic substrate has a pretreated surface.

9. Method according to claim 6, characterized in that the metal substrate has a surface pretreated with an organic acid.
